(19) United States
(12) Patent Application Publication
(10) Pub. No.: US 2007/0051418 A1
(43) Pub. Date: Mar. 8, 2007

(54) MULTILAYER TUBES

(76) Inventors: Brian A. ROWLES, Ravenna, OH (US); Gifford N. SHEARER, Wadsworth, OH (US)

Correspondence Address: BUCKINGHAM, DOOLITTLE & BURROUGHS, LLP, 3800 EMBASSY PARKWAY, SUITE 300, AKRON, OH, 44333-8332, US

(21) Appl. No.: 11/468,460

(22) Filed: Aug. 30, 2006

Related U.S. Application Data
(60) Provisional application No. 60/596,155, filed on Sep. 2, 2005.

(51) Int. Cl. F16L 11/00

(52) U.S. Cl. 138/137; 138/109

(57) ABSTRACT

The invention described relates to a composition for a multilayer tube having an inner and an outer layer. Preferably the inner layer of the tube has at least one at least partially crosslinked, preferably polyethylene, which is less flexible than the adjacent more flexible outer layer, which is preferably a thermoplastic elastomer. The inner and outer layers are typically coextruded during manufacture, with at least one overmolded end, preferably crosslinked, which generally has an internal diameter which is essentially the same as the internal diameter of the multilayer tube. The multilayer tube is typically crosslinked, preferably by electron beam.

### TECHNICAL FIELD

This invention relates generally to multilayer plumbing tubes in which at least one inner layer is used to provide rigidity and sufficient stiffness as well as required burst strength for the intended application and at least one second layer is used to improve the tube hoop strength and/or providing improved aesthetics. At least one overmolded end provides a leak-proof connection to a fluid source.

### BACKGROUND OF THE INVENTION

Current single layer tubing construction made of crosslinked polyethylene (“PEX”) is in common use for connecting water supply stops to terminal fittings (e.g., toilets, washing machines and faucets), and are commonly referred to as “risers.” The PEX riser is a popular choice in the industry due to its low cost and also for the fact that it does not impart any detectable odor or taste to the potable water transported therein. However, PEX risers are generally considered to be a stiff material and can be difficult to use when required to make relatively sharp bends to make connections between the supply stop and terminal fitting. As currently used in the industry, the polyethylene risers are crosslinked to about 70%, minimum specification being 65%.

The industry needs a low-cost tube which maintains the low odor and taste properties of PEX tubing, yet which is more flexible than the current PEX riser in common use, and which additionally has the capabilities of having an exterior appearance more similar to chrome-plated risers.

### SUMMARY OF THE INVENTION

In order to overcome the shortcomings of the Prior Art, a novel approach has resulted in a multilayer tube which achieves the benefits of burst strength of Prior Art thicker wall PEX tubing, but without the associated negative property of relatively poor flexibility inherent in the product. The approach reduces the wall thickness typically associated with PEX risers, thereby rendering them thinner but potentially more susceptible to kinking upon severe bending. However, this problem is solved by the incorporation of at least one second outer layer which is flexible at a thickness which is designed to prevent the kinking typically associated with thinner walled PEX.

In one embodiment of the invention, the multilayer tube is coextruded during its manufacture. When coextrusion is used to manufacture the riser, the at least two layers are chosen to be compatible so that at least a partial interfacial bond is imparted therebetween during the coextrusion process. Post-extrusion, the multilayer tube is crosslinked by various crosslinking methodologies known in the art, preferably however, using electron beam crosslinking.

The thickness of each respective tube layer is determined by a combination of factors which include the composition of the layer and the requirements needed for the end use application. Guidelines helpful in selecting the proper balance of thicknesses include the burst strength required (higher burst strengths requiring thicker inner tubes or higher degree of polymer crosslinking), the degree of flexibility desired (higher flexibility requiring thinner inner tubes) both coupled with a relatively more flexible outer tube to aid in the preventing of kinking of the inner tube by assisting in improving the hoop strength of the tube.

Accordingly it is an object of the invention to provide a novel approach to traditional riser plumbing tubes which increase the flexibility of traditional PEX tubes, yet retain the requisite amount of burst strength.

It is another object of the invention to provide a new composition of matter for a multilayer riser tube which uses a polyolefin, preferably crosslinked polyethylene inner tube and a thermoplastic (as extruded) outer tube.

It is yet another object of the invention to provide a new composition of matter for a multilayer riser tube which incorporates a pigmented layer into at least the radially outermost layer of the thermoplastic (as extruded) elastomeric outer tube.

It is still yet another object of the invention to provide a flexible riser with at least one sealing means, preferably selected from the group consisting of an overmolded end having a sealing surface and an overmolded anchor with adjacent nosecone or gasket sealing surface in which in a preferred embodiment the internal diameter of the overmolded end is essentially the same as the internal diameter of the riser tube.

These and other objects of the present invention will become more readily apparent from a reading of the following detailed description.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is an enlarged cross-sectional view of a Prior Art single layer PEX tube;

FIG. 2 is an enlarged cross-sectional view of a more flexible dual layer tube in comparison to the Prior Art single layer PEX tube of FIG. 1 illustrating a thinner inner PEX layer with a thicker outer layer of a thermoplastic elastomer;

FIG. 3 is an enlarged cross-sectional view of a three-layer tube illustrating a dual layer inner layer comprising a radially innermost layer of PEX and a layer of polypropylene (“PP”) with an outer layer of a thermoplastic elastomer;

FIG. 4 is an enlarged cross-sectional view of a four-layer tube illustrating a dual layer inner layer of FIG. 3 and a dual layer outer layer of two different, yet compatible thermoplastic elastomers;

FIG. 5 is an enlarged cross-sectional view of a two-layer tube similar to FIG. 2 except that the inner layer is thicker than the outer layer;

FIG. 6 is a cross-sectional view in longitudinal cross-section of a dual layer tube with opposed overmolded ends;

FIG. 7 is a side elevational view of one end of the tube of FIG. 5 with associated nut in cross-section;

FIG. 8 is a cross-sectional view in longitudinal cross-section of the dual layer tube of FIG. 5 illustrating an overmolded plastic insert and sealing surface in one end and an overmolded end without insert at the opposed end;

FIG. 9 is a cross-sectional view of one end of the riser illustrating an anchor overmold with a removable gasket sealing surface;

FIG. 10 is a graph of Force (lbs) measured over thirty second time intervals plotted to a maximum value for various polymer combinations, namely: (a) 0.070″ high density polyethylene (“HDPE”) PEX Prior Art single wall riser (70% crosslinked); (b) 0.070″ thermoplastic silicone vulcanizate (“TPSiV”) (PP-based) single wall riser; (c) 0.070″ TPSiV (HDPE-based) single wall riser; (d) 0.070″ TPSiV (HDPE-based) single wall riser; (e) 0.030″ TPSiV (HDPE-based) outer layer/0.040″ PEX inner layer (70% crosslinked); (f) 0.040″ TPSiV (HDPE-based) outer layer/0.030″ PEX inner layer (70% crosslinked); (g) 0.005″ low density polyethylene (“LDPE”) pigmented outer layer/0.055″ HDPE PEX inner layer (70% crosslinked); (h) 0.032″ Santoprene® outer layer/0.032″ PP inner layer wherein Santoprene is a registered trademark of Advanced Elastomers, L.P.; and (i) 0.050″ TPE Blend outer layer (Ex. #3)/0.030″ HDPE PEX inner layer (70% crosslinked);

| Series | Symbol | Description |
|---|---|---|
| (a) | ♦ | 0.070″ HDPE PEX Prior Art single wall riser |
| (b) | ▪ | 0.070″ TPSiV (PP-based) single wall riser |
| (c) | ▴ | 0.070″ TPSiV (HDPE-based) single wall riser |
| (d) | ◯ | 0.070″ TPSiV (HDPE-based) single wall riser |
| (e) | Δ | 0.030″ TPSiV (HDPE-based) outer layer/0.040″ |
| | | PEX inner layer |
| (f) | ● | 0.040″ TPSiV (HDPE-based) outer layer/0.030″ |
| | | PEX inner layer |
| (g) | □ | 0.005″ LDPE pigmented outer layer/0.055″ |
| | | HDPE PEX inner layer |
| (h) | + | 0.032″ Santoprene ® outer layer/0.032″ PP |
| | | inner layer |
| (i) | ⋄ | 0.050″ TPE Blend outer layer (Ex. #3)/0.030″ |
| | | HDPE PEX inner layer |

FIG. 11 is a view similar to FIG. 6 illustrating a pair of overmolded ends which end with the tip of the tube;

FIG. 12 is a view similar to FIG. 9 illustrating an anchor overmold and gasket in which the tube extends beyond the end surface of the gasket;

FIG. 13 is a view similar to FIG. 9 and FIG. 12 illustrating an anchor overmold with affixed nosecone sealing surface which extends beyond the tip of the tube; and

FIG. 14 is a view similar to FIG. 11 illustrating a sealing surface overmold at one end and an anchor overmold with separable nosecone at the opposed end.

### DETAILED DESCRIPTION OF THE INVENTION

The multilayer tubes of the present invention provide the next generation product to current single layer crosslinked polyethylene tubes (70% crosslinked) which are presently available and overcome the inherent lack of flexibility of these tubes which makes installation difficult in tight spaces, particularly with do-it-yourselfers. In order to meet this need, a series of new compositions has been developed which simultaneously make the tubes more flexible, yet resistant to kinking after bending into a tight radius and which retain the requisite amount of burst strength for the intended application. This increased degree of flexibility does not come at the expense of an increased degree of “kinking.” As is well known in the art, kinking provides a disruption in the fluid pathway, which decreases flow through the tube. With liquids, this is a particular problem in that it also decreases pressure, leading to consumer complaints.

In a preferred embodiment, the multilayer tubes are coextruded, often using a dual head extruder in which one polymer is fed through a first hopper into a die and forms the inner tube while a second polymer is fed through a second hopper into the same die and forms the outer tube. While a coextruded tube is described, there is no need to limit the invention to two-layer tubes. In fact, as many layers of polymers can be added as economic or end-use application considerations will support.

As illustrated in FIG. 1, typical currently available riser tubes 10 generally have a nominal wall thicknesses of between about 0.060″-0.080″. They are made of a single layer 12 of polyethylene which is 70% crosslinked. When made of crosslinked polyethylene or PEX, these monolayer tubes are generally considered to be stiff by the industry. Per the test protocol described hereinbelow, stiff means approximately 14-15 pounds force per modified ASTM 790 testing protocol using an 80 mm span. In order to improve the ease of installation of these tubes, in one aspect of the present invention, the thickness of the polyethylene inner layer (the crosslinking typically comes after the product is manufactured) is reduced down to the range of approximately 0.025″-0.060″ inclusive, more preferably approximately 0.030″-0.055″ inclusive, a thickness at which adequate burst strength is still present (after crosslinking), but for which there may or may not be sufficient hoop strength (particularly at the thinner dimensions) to prevent the internal diameter (“ID”) from collapsing when the product is bent into a tight radius. Hoop strength is therefore a measure of the resistance against external compression or radial strength. As used in this application, a “kink” is present when there is a crease along the inner circumference of the tube when bent that decreases liquid flow through the tube to a point where it is insufficient to meet the needs of the intended end-use application or to which the consumer notices. It is recognized however, that when the inner layer is not crosslinked, the thickness of this layer may need to be increased to the range of approximately 0.025″-0.075″ inclusive. This is particularly the case when polypropylene is used in the inner layer.

As illustrated in FIG. 2, illustrating a dual layer construction 20, inner polymer layer 24 having an interior surface 22 can generally be any thermoplastic polymer provided that the interior wall has sufficient thickness to achieve sufficient burst strength for the intended application. In a preferred embodiment, this inner polymer is polyethylene which is subsequently crosslinked to some required degree, the amount being determined by the degree of burst strength required. There is an inverse relationship between the degree of crosslinking and the thickness of this inner layer. The higher the degree of crosslinking, the thinner the tube can be to still achieve the burst requirement. A non-limiting list of examples of other inner polymers includes polyolefins, specifically polyethylene (high density polyethylene, medium density polyethylene, low density polyethylene, linear low density polyethylene), polypropylene (isotactic, syndiotactic), polyvinyl chloride and polyamides. In a preferred embodiment, these polymers are crosslinked after manufacturing into a tube configuration, preferably by exposure to electron beam radiation.

In order to minimize the collapsing ID issue, and/or to provide additional hoop strength, a second more flexible polymer 26 in association with inner polymer layer 24, is added. In one aspect of the invention, the thickness of this second outer layer is approximately 0.003″-0.050″, more preferably 0.005″-0.040″. The composition of this at least one second outer layer can be quite varied. A non-limiting list of examples of outer polymers includes thermoplastic elastomers (e.g., SEBS or styrenic block copolymers with an hydrogenated midblock of styrene-ethylene/butylene-styrene, SBS or styrene-butadiene-styrene rubber, EVA or ethylene vinyl acetate), thermoplastic vulcanizates (e.g., Santoprene® is an ethylene-propylene copolymer and a trademark of Advanced Elastomer Systems, L.P.), thermoplastic urethanes, chlorinated polyvinyl chloride, linear low density polyethylene, plastomers and amide alloys. As described in this application, thermoplastic vulcanizates includes silicone vulcanizates (“TPSiV™”). These resins in their basic form are thermoplastic elastomer compositions wherein a silicone gum is dispersed in a thermoplastic resin and dynamically vulcanized therein. The class of thermoplastic resins is quite broad and encompasses the incorporation of resins which include polyolefins and poly(butylene terephthalate), grafted fluorocarbon resins and blends thereof, polyamide resins and blends thereof, saturated polyesters other than poly(butylene terephthalate) and blends thereof, polyamides or polyesters and blends thereof, polyolefins or styrenic block copolymers and blends thereof, compatibalized polyamide resins and blends thereof, compatibalized polyester resins and blends thereof.

As used in this application, the determination of flexibility is done using ASTM D790 in which tubing of any known inner and outer diameter is cut to six inch samples and tested using appropriate equipment. Typical maximum values for Prior Art single layer PEX (70% crosslinking) tubing (0.070″ wall thickness) is approximately 14-15 lbs. force using an 80 mm testing span. This value is considered too stiff for the industry. Typical maximum values for a completely non-PEX riser tube (e.g., single layer thermoplastic elastomer, e.g., TPSiV™ is approximately 5-7 pounds force (0.070″ wall thickness) using the same testing span. However, while the tube stiffness is significantly reduced, thereby rendering the tube more flexible, the single layer TPSiV tube has insufficient burst strength for intended end use applications. Therefore, what is needed is a combination dual layer tube which utilizes just a sufficient amount of polyolefin, preferably crosslinked polyethylene or polypropylene, most preferably PEX for sufficient burst strength, with a second thermoplastic elastomeric polymer to aid in hoop strength, particularly as the inner layer (crosslinked or non-crosslinked) is reduced in thickness.

FIG. 3 illustrates another embodiment of this invention illustrating a three layer construction 30 in which the inner layer is actually two different layers. The radially innermost layer 32 is a crosslinked polyethylene for superior odor and taste characteristics while the adjacent layer 34 is polypropylene (for cost considerations). In a preferred embodiment, these layers are coextruded thereby forming a bond between the layers in light of the inherent compatibility of the two polyolefin layers, although it is recognized that this is not an absolute requirement. The radially outermost layer is a thermoplastic elastomer. This outer layer is chosen for the intended end use and aids in imparting hoop strength to the material as well as aesthetic purposes, in that this outer layer is often colored (e.g., pure white, pearl white, black, light brass, satin nickel, storm gray, chrome, cool gray, green, pewter or gray), such colorant added in approximately 1-5% by weight, preferably 2-4%, to either the outer layer or also to the inner layer(s) in approximately the same ratios. The need to color the inner layer(s) is often dependent upon the thickness of the outer layer(s) employed.

FIG. 4 illustrates a another embodiment of this invention illustrating a four layer construction 40 in which both the inner and outer layers are actually two different layers. The radially innermost layer 42 is a crosslinked polyethylene for superior odor and taste characteristics while the adjacent layer 44 is polypropylene (for cost considerations). In a preferred embodiment, these layers are coextruded thereby forming a bond between the layers in light of the inherent compatibility of the two polyolefin layers, although it is recognized that this is not an absolute requirement. The two radially outermost layers are thermoplastic elastomers. This outer layers are chosen for the intended end use and aid in imparting hoop strength to the material as well as aesthetic purposes, in that the radially outermost layer is often colored as hereinabove described. As with the inner layers, the at least two outermost layers are preferably coextruded. The need to color the inner layer(s) is often dependent upon the thickness of the outer layer(s) employed.

As illustrated, particularly in FIGS. 3-4 is that the riser of the invention must have at least one crosslinked polymer in at least one inner layer, preferably the radially innermost layer, preferably of crosslinked polyethylene so that no odor or taste is imparted to the liquid which flows through the riser tube and which provides much of the burst strength of the tube. The outer layer of the tube must have at least one thermoplastic layer which aids in preventing kinking by aiding in hoop strength of the riser tube.

FIG. 5 illustrates that the relative thicknesses of the two layers in the riser 90 may be interchanged. For some applications, the inner tube comprising at least one crosslinked polymeric layer (preferably PEX) 84 can be thicker than the outer polymeric layer 82. In this configuration, the outer layer is primarily used for decorative effect, and is often pigmented.

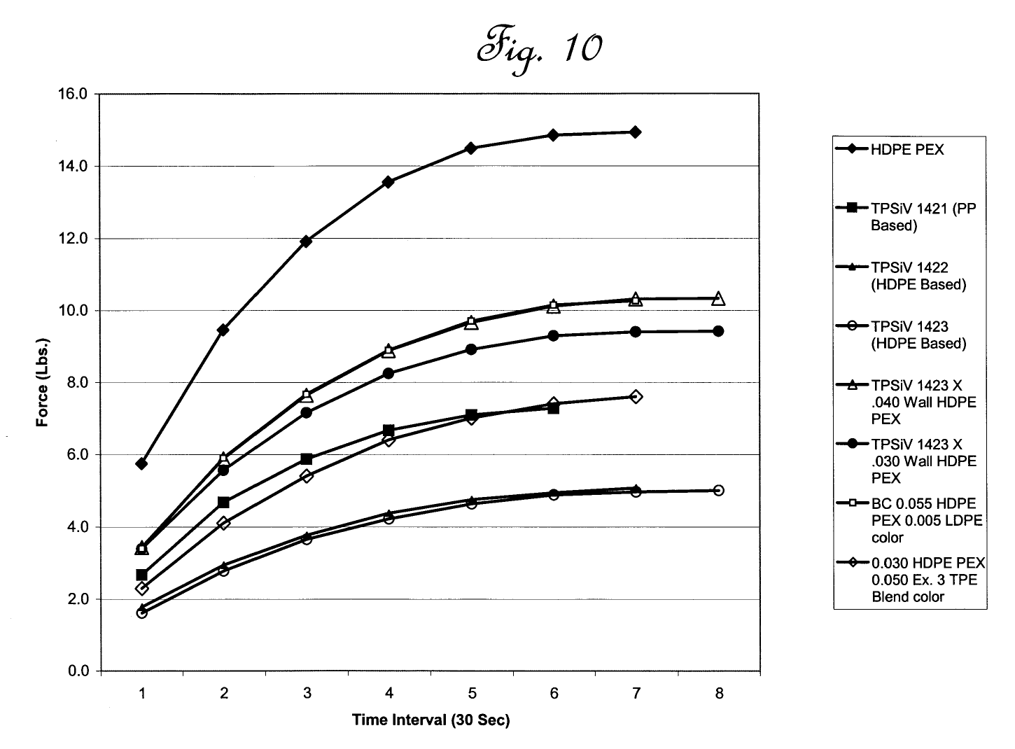

As indicated in FIG. 10, a series of tubes were tested for flexibility, the results of which are shown in Table I using a time interval of 30 seconds and measuring the force (lbs) per testing protocol described below as well as indicating whether the riser passed a hot burst test of 400 psi at 180° F.

TABLE I

| | Se- | | | | | | | | | |
|---|---|---|---|---|---|---|---|---|---|---|
| | ries | 1 | 2 | 3 | 4 | 5 | 6 | 7 | 8 | Burst¹ |
| (a) | ♦ | 5.7 | 9.5 | 11.9 | 13.5 | 14.5 | 14.8 | 14.9 | | P |
| (b) | ▪ | 2.7 | 4.7 | 5.9 | 6.7 | 7.1 | 7.3 | | | F |
| (c) | ▾ | 1.8 | 2.9 | 3.8 | 4.4 | 4.7 | 4.9 | 5.1 | | F |
| (d) | ◯ | 1.6 | 2.8 | 3.7 | 4.2 | 4.6 | 4.9 | 5.0 | 5.0 | F |
| (e) | Δ | 3.4 | 5.9 | 7.6 | 8.9 | 9.7 | 10.1 | 10.3 | 10.3 | P |
| (f) | ● | 3.4 | 5.6 | 7.2 | 8.2 | 8.9 | 9.3 | 9.4 | 9.4 | P |
| (g) | □ | 3.4 | 5.9 | 7.7 | 8.9 | 9.7 | 10.1 | 10.3 | | P |
| (h) | + | 1.6 | 3.0 | 3.9 | 4.5 | 4.8 | 4.9 | 5.1 | | P |
| (i) | ⋄ | 2.3 | 4.1 | 5.4 | 6.4 | 7.0 | 7.4 | 7.6 | | P |

¹Pass (P)/Fail (F)

The testing protocol employed was a modified ASTM D790 testing protocol to test the tubing using an 80 mm span. Per test protocol, force load at 30 second intervals were measured using the constant 80 mm test span, until a maximum load was generated. Measurements were carried out at least one minute past the noted maximum load. Testing was done on 6″ tubing samples of standard typical size with processing as comparable as possible. All tubing was conditioned at the same time in the same environment. Data reflects force load at 30 second intervals and is plotted to maximum values. The Figure shows that single layer high density ˜70% crosslinked polyethylene tubing exhibits sufficient burst strength but is too stiff (˜15 lbs force). Single layer thermoplastic tubes (e.g., TPSiV), both high density polyethylene based and polypropylene based were tested, and which were sufficiently flexible (i.e., 5-7 lbs force) but exhibited unacceptably low burst strength values.

Combinations of the two polymers however, e.g., TPSiV 1423 (HDPE based—0.040″ wall thickness) outer layer/0.030″ wall thickness HDPE PEX inner layer (70% crosslinked) as well as TPSiV 1423 (HDPE based—0.030″ wall thickness) outer layer/0.040″ wall thickness HDPE PEX inner layer (70% crosslinked), did exhibit acceptable burst strength in addition to the increased flexibility (10.3-9.4 lbs force, which are lower values to the Prior Art 14.9 lbs for standard PEX risers). Additionally, multilayer polymer blends, e.g., TPE polymer blend of example #3—0.050″ outer wall thickness/0.030″ HDPE PEX wall thickness inner layer (70% crosslinked), also exhibited acceptable burst strength coupled with increased flexibility of approximately 7.6 lbs force (reduced from 14.9 lbs for Prior Art HDPE PEX). It has additionally been discovered that multilayer tube combinations of 0.005″ LDPE outer wall thickness/0.055″ HDPE PEX inner wall thickness (70% crosslinked) possessed acceptable burst strength coupled with increased flexibility of approximately 10.3 lbs force (reduced from 14.9 lbs for Prior Art HDPE PEX).

Using the testing protocols specified in ASTM F877-05 (Sec. 6.3) and ASTM F876-05 (Sec. 7.7), it is desired to have a hot burst strength of approximately 300 psi, more preferably 400 psi, most preferably 500 psi at 180° F. Using this criteria, TPSiV single wall tubes cannot pass the above tests. While they are sufficiently flexible, they do not possess sufficient burst strength, thereby illustrating the necessity for at least one second layer of some degree of crosslinked material in the riser tube, preferably as the inner layer of the tube.

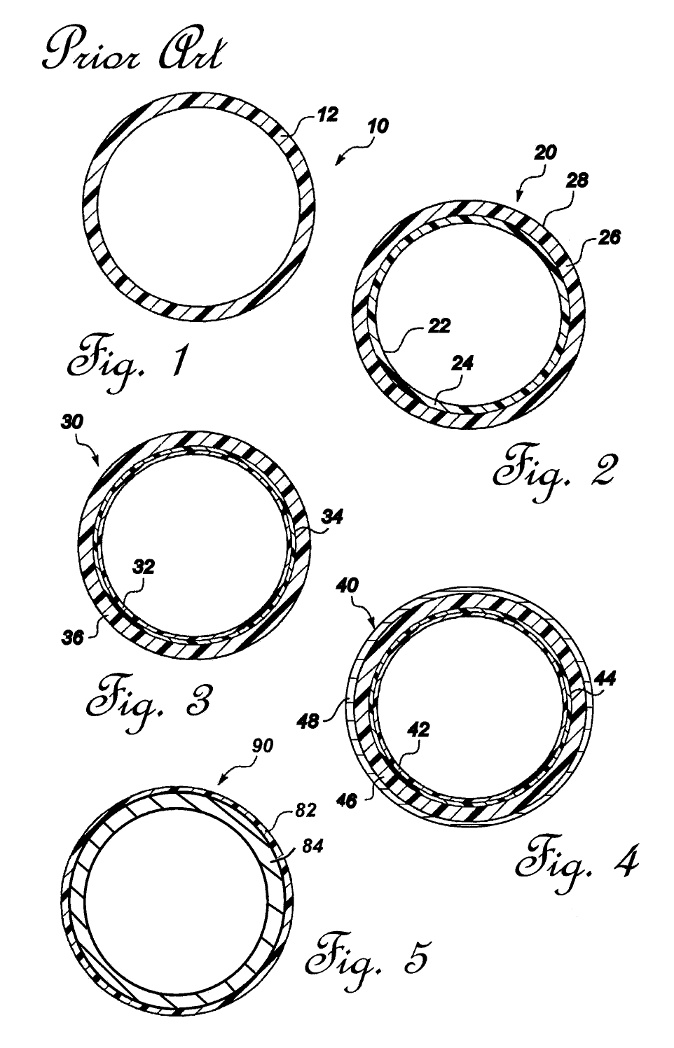

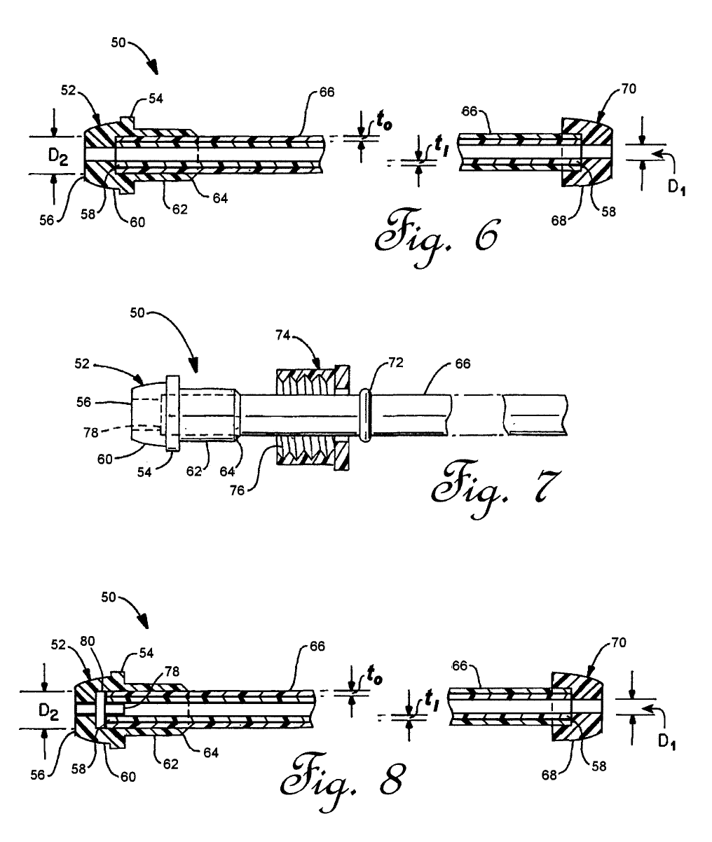

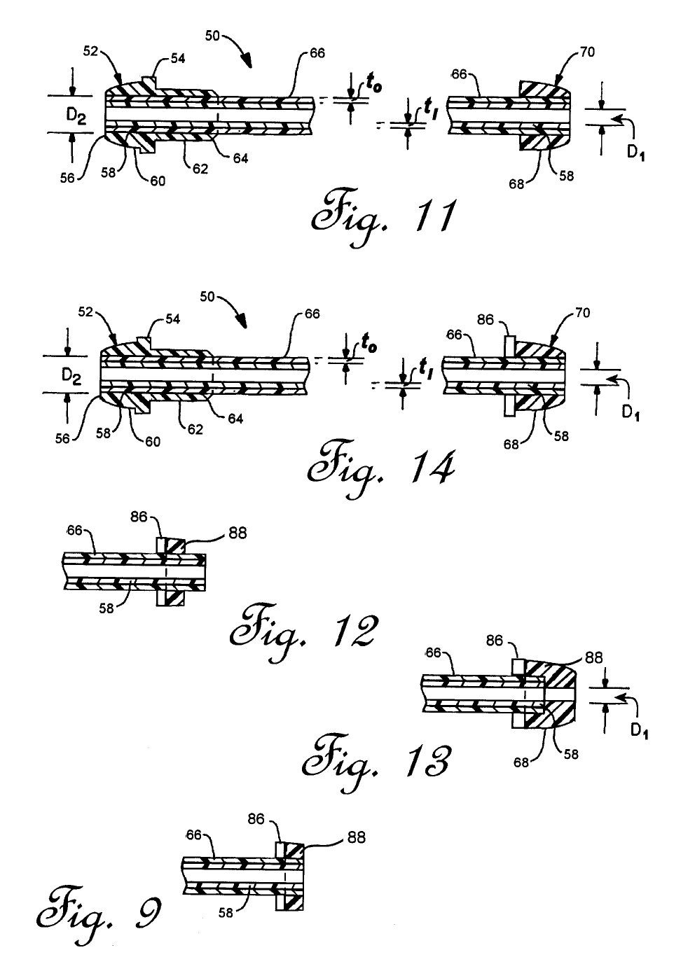

As illustrated in FIGS. 6-7, the riser tubes 50 include a pair of overmolded ends 52,70. Overmolded end 52 has a cup-shaped sealing surface 60 with radially projecting shelf 54 and sealing cylindrical area 62 in bonding relationship with exterior surface 64 of radially outermost layer 66 of riser tube 50. In the dual layer configuration of FIG. 6, the radially innermost layer 58 has a thickness of tᵢ while radially outermost layer 66 has a thickness of tₒ. The overall riser tubing thickness is D₂ while the I.D. of the tube is D₁. Opposed overmolded end 70 has a radiused sealing surface 68. The two sealing surface can either be the same or different as illustrated. Each end of riser tube 50 has an outwardly-facing nut 74 (only one shown) with threaded flights 76 to pull each sealing surface into sealing engagement with a mating receptacle. Optionally, at least one retaining ring 72 is on the riser tube to prevent the nut from movement about the entire exterior surface of the riser between the respective sealing surfaces. FIG. 8 illustrates that the at least one overmolded end may include the insertion of a metal or plastic insert 78 having a radially extending shelf 80, which is anchored in place by the overmold. This is effective when the inner polymer has a melt processing temperature which is close to that of the overmolding operation. FIG. 11 illustrates that the at least one overmolded sealing means portion of the multilayer tube need not extend beyond the tubing ends of the multilayer tube, but rather may coterminate at the tip. FIG. 14 illustrates that the overmolded sealing means need not necessarily have an overmolded sealing surface 60, but have an anchor overmold 86 or radially extending anchor shelf with removable nosecone having sealing surface 68 for leak-proof engagement with a mating fitting.

FIG. 9 illustrates an alternative embodiment of a sealing surface within the scope of the invention in which an anchor overmold 86 is molded about the radial outer circumference of the tube. The radially expanding shelf acts as an anchor for a removable nosecone 88, illustrated to be a gasket in the figure. FIG. 12 illustrates that anchor overmold 86 about the outer circumference of outer layer 66 may be positioned so as to not have the end of the tube coterminate with the sealing surface of nosecone or gasket 88 while FIG. 13 illustrates that in some embodiments, sealing surface 68 of nosecone 88 may extend beyond the tip of the multilayer tube.

While the precise composition of the overmolded polymer is not required to be of any specified polymer, in general, there are several guidelines which are applicable in the practice of this invention. It is of course, recognized that the precise operating conditions utilized in the overmolding process are well-known in the art and are specific to each injection molded polymer. It is well within the skill of the art to determine the applicable conditions which will result in the appropriate overmolded polymer and riser tube combination. As mentioned previously, the dual-layer riser can be a thermoplastic or a thermoset. At least one key is that the overmolded polymer must be capable of forming a leak-proof bond, either chemical or physical, with the exterior surface of the riser.

The combination of the above polymers must satisfy at least two simultaneous conditions. First, the riser must not soften and begin melt flow to the point where it looses structural integrity and second, the overmolded polymer must be capable of forming an essentially leak-proof interface with the exterior surface of the riser, preferably through either a chemical and/or physical bond between the underlying polymer and the overmolded polymer. One of the keys is the recognition that the riser tubing must be capable of maintaining structural integrity during the overmolding conditions during which the overmolded polymer is in melt flow.

While using polymer compositions which have differing softening points is one way to achieve the above objective, there are alternatives, which would include the use of two compositions which have the same softening point, but which are of different thicknesses, thereby through manipulation of the time, temperature and pressure conditions experienced during the molding operation, the plastic conduit would not experience melt flow, even though it had a similar softening point or range. It is also possible that through the incorporation of various additives in the polymeric compositions, e.g., glass fibers, heat stabilizers, anti-oxidants, plasticizers, etc., that the softening temperatures of the polymers may be controlled.

In a preferred embodiment of the invention, the composition of the overmolded polymer will be such that it will be capable of at least some melt fusion with the composition of the plastic conduit, thereby maximizing the leak-proof characteristics of the interface between the exterior surface of the riser and injection overmolded polymer. There are several means by which this may be effected. One of the simplest procedures is to insure that at least a component of the riser and that of the overmolded polymer is the same or within the same class of polymers. Alternatively, it would be possible to insure that at least a portion of the polymer composition of the riser and that of the overmolded polymer is sufficiently similar or compatible so as to permit the melt fusion or blending or alloying to occur at least in the interfacial region between the exterior surface of the riser and the interior region of the overmolded polymer. Another manner in which to state this would be to indicate that at least a portion of the polymer compositions of the riser and the overmolded polymer are miscible.

In yet another embodiment, composites of rubber/thermoplastic blends are useful in adhering to thermoplastic materials used in the plastic conduit. These blends are typically in the form of a thermoplastic matrix containing rubber distinct phases functionalized and vulcanized during the mixing with the thermoplastic. The composite article is then obtained by overmolding the vulcanized rubber/thermoplastic blend onto the thermoplastic conduit. In this manner, the cohesion at the interface between these two materials is generally higher than the tensile strength of each of the two materials. The quantity of vulcanizable elastomer may be from 20 to 90% by weight of the vulcanizable elastomer block copolymer combination. This block copolymer comprises a polyether or amorphous polyester block as the flexible elastomeric block of the thermoplastic elastomer while polyamide, polyester or polyurethane semicrystalline blocks for the rigid elastomeric block of the thermoplastic elastomer. In this approach, it is postulated, without being held to any one theory of operation or mechanism, that the leak-proof aspect of this linkage utilizes a phenomenon typically used in the formation of moisture-proof electrical connections, i.e., dynamic vulcanization shrink wrap. In this manner, the overmolded polymer is formed having a internally latent stresses which upon the application of heat, permit the relaxation of the stresses with resulting contraction of various polymeric strands within the composition during cooling.

Various two layer combinations which meet the above criteria include the following illustrated in Table II. The compositions listed reflect those of the final riser product after it has been crosslinked, which is typically effected by passage of the riser tube through an electron beam, although alternative modes of crosslinking are within the scope of this invention. The percentages adjacent the tube columns refer to the amount added in relationship to the total weight of the tube and similarly refer to the percentage figures adjacent the overmold column.

TABLE II

| | Tube | Tube | | Tube | | Overmold | | Overmold | |
|---|---|---|---|---|---|---|---|---|---|
| Riser | Layer | Material | % | Colorant | % | Material³ | % | Colorant | % |
| Pearl White | Inner⁴ | PEX⁶ | 98 | Pure White¹ | 2 | PEX⁶ | 98 | Cool Grey² | 2 |
| | Outer⁵ | LDPE⁷ | 96 | Pearl White² | 4 | | | | |
| Polished Brass | Inner⁴ | PEX⁶ | 98 | Black¹ | 2 | PEX⁶ | 98 | Green² | 2 |
| | Outer⁵ | LDPE⁷ | 96 | Light Brass² | 4 | | | | |
| Satin Nickel | Inner⁴ | PEX⁶ | 98 | Black¹ | 2 | PEX⁶ | 98 | Pewter² | 2 |
| | Outer⁵ | LDPE⁷ | 96 | Satin Nickel² | 4 | | | | |
| Chrome | Inner⁴ | PEX⁶ | 98 | Storm Gray¹ | 2 | PEX⁶ | 98 | Gray² | 2 |
| | Outer⁵ | LDPE⁷ | 96 | Chrome² | 4 | | | | |

¹PolyOne is the pigment colorant supplier
²Clariant is the pigment colorant supplier
³The degree of crosslinking of the radially innermost PEX layer under the overmolded area is approximately 55%
⁴0.050-0.055″ nominal wall thickness
⁵˜0.005″ nominal wall thickness
⁶Degree of crosslinking is approximately 65%
⁷Degree of crosslinking is approximately 53-55%

### EXAMPLE #1

A multilayer tube was made by coextrusion using an inner layer of polypropylene at 0.065″ and an outer layer of Santoprene at 0.015″. Two high density polyethylene ends with sealing surfaces as illustrated in FIG. 5 were overmolded onto the multilayer riser tube and crosslinked via electron beam processing.

### EXAMPLE #2

A multilayer tube was made by coextrusion using an inner layer of high density polyethylene at 0.030″ and an outer layer of linear low density polyethylene at 0.050″. Two linear low density polyethylene ends with sealing surfaces as illustrated in FIG. 5 were overmolded onto the multilayer riser tube and portions of the tube crosslinked via electron beam processing.

### EXAMPLE #3

A multilayer tube was made by coextrusion using an inner layer of high density polyethylene at 0.030″ and an outer layer of a blended thermoplastic elastomer at 0.050″. The outer layer blend consisted of 24% ultra low density ethylene octane copolymer (0.857 g/cc), 6% amorphous very low diene containing ethylene-propylene diene terpolymer (0.84-0.9 g/cc), 26% ethylene octane copolymer (0.885 g/cc), 40% linear low density polyethylene (0.92 g/cc) and 4% silver pigment). Two high density polyethylene ends with sealing surfaces as illustrated in FIG. 5 were overmolded onto the multilayer riser tube and crosslinked via electron beam processing.

### EXAMPLE #4

A non-limiting series of examples applicable to the composition of the multilayer tubes of this invention include the following polymers listed in Table III.

TABLE III

| Inner Material | Outer Material | Inner Material | Outer Material |
|---|---|---|---|
| polypropylene | TPV (e.g., Santoprene) | MDPE | LLDPE |
| polypropylene | TPE (e.g., SEBS, | MDPE | Plastomer |
| | SBS) | | |
| polyethylene | TPU - urethane | MDPE | Plastomer - |
| | | | PE blends |
| polyethylene | TPV | LLDPE | Plastomer |
| polyethylene | TPE | LLDPE | Plastomer - |
| | | | PE blends |
| PVC | CPVC | PAX ETG61 | TPV |
| HDPE | LLDPE | PAX ETG61 | TPE |
| HDPE | Plastomer | Polyamides | Amide alloys |
| | (e.g., Engage) | | (TPE) |
| HDPE | Plastomer - PE blends | HDPE | EVA |

As used in this application, the determination of bend radius such that a kink in the tubing will not result when compared to existing Prior Art products encompasses the following guidelines. A “standard” value for Prior Art PEX tubing is defined by the fact that it will not kink when subjected to a bending radius of six times the outer diameter of the tube as per ASTM F876. Any tubing product that can bend around a mandrel having a radius that is less than six times the outer diameter is considered more flexible than the standard product. Therefore, the Prior Art teaches that the flow rate of liquid through a tube which is bent around a mandrel will remain essentially the same as the flow rate through a straight tube provided that the bending radius is more than six times the outer diameter of the tube. Prior Art PEX tubing experiences a decrease in flow rate when this bending radius is less than six times the outer diameter of the tube. When using the multilayer tubes of the instant invention, the bending radius can be decreased (i.e., becomes more severe) and still maintain the same flow rates as with an unbent tube. In a preferred embodiment, the flow rate remains essentially the same in the bent and straight configurations of the multilayer tube with bending radii which are as small as 4.0 times the outer diameter of the multilayer tube, more preferably as small as 3.0 times the outer diameter of the multilayer tube, most preferably as small as 2.0 times the outer diameter of the tube.

### EXAMPLE #5

In order to illustrate the improved flexibility of the multilayer tubes, one multilayer tube was made having a PEX (70% crosslinked) inner layer with a wall thickness of 0.055″ and having an LDPE outer layer with a wall thickness of 0.005″ pigmented with Satin Nickel color. The tube had an internal diameter (I.D.) of 0.205″ and an outer diameter (O.D.) of 0.334″. For comparison purposes, a standard PEX (70% crosslinked) single layer riser was used having an I.D. of 0.240″ with an O.D. of 0.375″. Each tube was wound around a mandrel of varying radii to create different degrees of bending to test the flexibility of the tubes, using ASME 112.18.6-2003 Sec. 4.4, modified to include various radii mandrels, specifically 10 times, 6 times, and 2 times the O.D. of each tube using 15 psi. Table IV summarizes the results of the tests.

TABLE IV

| | | Single | | |
|---|---|---|---|---|
| | | Layer Tube | | Multilayer Tube |
| OD | Mandrel | Flow Rate | Mandrel | Flow Rate |
| Ratio | Radius | (gal./min.) | Radius | (gal./min.) |
| N/A | Straight flow | 4.13 | Straight Flow | 2.41 |
| 10x | 3.750″ | 4.07 | 3.340″ | 2.43 |
| 6x | 2.250″ | 3.99 | 2.004″ | 2.43 |
| 2x | 1.500″ | 3.94 | 1.336″ | 2.40 |

As is clearly seen from the above table, the multilayer tube was significantly more flexible than the single layer Prior Art tube as measured by the fact that due to I.D. compression and/or deformation upon winding about a mandrel, there was a 4.6% decrease in flow rate compared to a 0.4% decrease. The mutilayer tube would be easier to install and be capable of bending to a tighter radius without the end-user noticing any decrease in flow rate for the intended application.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the invention is by way of example, and the scope of the invention is not limited to the exact details shown or described. This invention has been described in detail with reference to specific embodiments thereof, including the respective best modes for carrying out each embodiment. It shall be understood that these illustrations are by way of example and not by way of limitation.

What is claimed is:

1. A flexible multilayer tube having a thickness and an internal diameter which comprises:
An inner tube comprising at least one at least partially crosslinked layer for burst strength;
An outer tube comprising at least one layer selected from the group consisting of a thermoplastic and a thermoset;
Said multilayer tube having a stiffness which is no greater than 80% of a single layer crosslinked tube of the same thickness as said multilayer tube, said single layer tube having essentially the same degree of crosslinking as said at least one at least partially crosslinked layer in said inner tube;
Said multilayer tube essentially maintaining a flow rate through said tube when bent around a mandrel having a radius which is less than 6 times a diameter of said tube;
Said multilayer tube having at least sealing means on at least one end.

2. The tube of claim 1 wherein
said at least one sealing means is selected from the group consisting of an overmolded end having a sealing surface and an overmolded anchor with a separable sealing surface.

3. The tube of claim 1 wherein
Said at least one sealing means has an internal diameter which is essentially the same as the internal diameter of said multilayer tube.

4. The tube of claim 1 wherein
Said at least one crosslinked layer for said inner tube is selected from the group consisting of high density polyethylene, medium density polyethylene, low density polyethylene, linear low density polyethylene, isotactic polypropylene, syndiotactic polypropylene, polyvinyl chloride and polyamide.

5. The tube of claim 1 wherein
Said inner tube wall thickness is between approximately 0.030″ and 0.060″,
Said outer tube wall thickness is between approximately 0.003″ and 0.050″,
Said inner and outer tube wall thicknesses totaling to between approximately 0.040″ and 0.080″.

6. The tube of claim 4 wherein
Said crosslinked polyethylene has a degree of crosslinking between approximately 25% and 95% inclusive.

7. The tube of claim 5 wherein
Said outer layer further comprises a thermoplastic elastomer selected from the group consisting of thermoplastic elastomers, thermoplastic vulcanizates, thermoplastic urethanes, chlorinated polyvinyl chloride, linear low density polyethylene, plastomers and amide alloys.

8. The tube of claim 7 wherein
Said thermoplastic elastomer is a silicone vulcanizate.

9. The tube of claim 1 wherein
At least one layer of said outer tube further comprises a pigment.

10. The tube of claim 1 wherein
Said overmolded end is selected from the group consisting of a thermoplastic and a thermoset.

11. The tube of claim 1 wherein
Said overmolded end is polyethylene.

12. The tube of claim 11 wherein
Said polyethylene is at least partially crosslinked.

13. A process for improving the flexibility of a riser tube which comprises the steps of:
Extruding a polyolefin having a wall thickness which is less than about 0.060″;
Adding at least one second thermoplastic polymer to an exterior of said riser tube forming a multilayer tube;
Overmolding at least one sealing means onto at least one end of said tube; and
At least partially crosslinking at least one layer of said tube.

14. The process of claim 13 wherein
Said step of adding said at least one second thermoplastic polymer is by coextrusion, said multilayer tube having a stiffness which is no greater than 80% of a single layer crosslinked tube of the same thickness as said multilayer tube.

15. The process of claim 14 wherein
Said at least one overmolded end has an internal diameter which is essentially the same as the internal diameter of said tube.

16. The process of claim 13 wherein
Said at least one crosslinked layer is selected from the group consisting of high density polyethylene, medium density polyethylene, low density polyethylene, linear low density polyethylene, isotactic polypropylene, syndiotactic polypropylene, polyvinyl chloride and polyamide; and
Said added outer layer further comprises a thermoplastic elastomer selected from the group consisting of thermoplastic elastomers, thermoplastic vulcanizates, thermoplastic urethanes, chlorinated polyvinyl chloride, linear low density polyethylene, plastomers and amide alloys.

17. The process of claim 13 wherein
Said inner tube wall thickness is between approximately 0.030″ and less than 0.060″,
Said outer tube wall thickness is between approximately 0.003″ and 0.050″,
Said inner and outer tube wall thicknesses totaling to between approximately 0.040″ and 0.080″.

18. The process of claim 13 wherein
Said step of crosslinking is to between approximately 25% and 95% inclusive.

19. The process of claim 13 wherein
Said at least one second thermoplastic polymer further comprises a pigment.

20. The process of step 13 wherein
Said at least one sealing means is selected from the group consisting of an overmolded end having a sealing surface and an overmolded anchor with separable sealing surface.

21. A flexible multilayer connector tube having a thickness and an internal diameter which comprises:
An inner tube comprising at least one polyolefin layer;
An outer tube comprising at least one layer selected from the group consisting of a thermoplastic and a thermoset;
Said inner tube being less flexible than said outer tube;
Said multilayer tube having a stiffness which is no greater than 80% of a single layer tube of the same thickness as said multilayer tube;
Said multilayer tube maintaining a flow rate through said tube when bent around a mandrel having a radius which is less than 6 times a diameter of said tube; and
Said multilayer tube having at least sealing means on at least one end, said sealing means having an internal diameter which is no smaller than the internal diameter of said multilayer tube.

22. The tube of claim 21 wherein
said at least one sealing means is selected from the group consisting of an overmolded end having a sealing surface and an overmolded anchor with separable sealing surface.

23. The tube of claim 22 wherein
Said overmolded end of said at least one sealing means has an internal diameter which is essentially the same as the internal diameter of said multilayer tube.

24. The tube of claim 21 wherein
Said at least one polyolefin layer is a crosslinked layer wherein the polyolefin is selected from the group consisting of high density polyethylene, medium density polyethylene, low density polyethylene, linear low density polyethylene, isotactic polypropylene, and syndiotactic polypropylene.

25. The tube of claim 21 wherein
Said inner tube wall thickness is between approximately 0.030″ and 0.075″ inclusive,
Said outer tube wall thickness is between approximately 0.003″ and 0.050″,
Said inner and outer tube wall thicknesses totaling to between approximately 0.040″ and 0.080″.

26. The tube of claim 24 wherein
Said crosslinked layer is polyethylene having a degree of crosslinking between approximately 25% and 95% inclusive.

27. The tube of claim 25 wherein
Said outer layer further comprises a thermoplastic elastomer selected from the group consisting of thermoplastic elastomers, thermoplastic vulcanizates, thermoplastic urethanes, chlorinated polyvinyl chloride, linear low density polyethylene, plastomers and amide alloys.

28. The tube of claim 27 wherein
Said thermoplastic elastomer is a silicone vulcanizate.

29. The tube of claim 21 wherein
At least one layer of said outer tube further comprises a pigment.

30. The tube of claim 22 wherein
Said overmolded end is a thermoplastic.

31. The tube of claim 30 wherein
Said thermoplastic is polyethylene.

32. The tube of claim 31 wherein
Said polyethylene is at least partially crosslinked.
